(19) United States
(12) Patent Application Publication
(10) Pub. No.: US 2006/0080117 A1
(43) Pub. Date: Apr. 13, 2006

(54) Maintaining integrity within an adaptive value chain involving cross enterprise interactions

(75) Inventors: Derek W. Carr, Fairless Hills, PA (US); Peter P. Eacmen, West Roxbury, MA (US); Ronny A. Pena, New York, NY (US); Ajamu A. Wesley, Concord, MA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/963,351

(22) Filed: Oct. 12, 2004

(51) Int. Cl. G06Q 99/00; G06Q 40/00; G06Q 20/00

(52) U.S. Cl. 705/1; 705/16; 705/44

(57) ABSTRACT

The present invention is a method, system and apparatus for maintaining transactional integrity within an adaptive value chain involving cross enterprise interactions. In the present invention, transactional integrity can be maintained in a cross-enterprise business process management system by managing business transformation operations among cross-enterprise interactions to produce an adaptive value chain. At the same time, atomicity can be enforced among the business transformation operations and the cross-enterprise interactions.

### BACKGROUND OF THE INVENTION

1. Statement of the Technical Field

The present invention relates to the field of computerized business-to-business interactions and more particularly to integrating cross enterprise business processes.

2. Description of the Related Art

The achievement of universal interoperability between applications by using Web standards remains the principal goal of Web Services. Web Services use a loosely coupled integration model to allow flexible integration of heterogeneous systems in a variety of domains including business-to-consumer, business-to-business and enterprise application integration. The following basic specifications originally defined the Web Services space: the Simple Object Access Protocol (SOAP), the Web Services Description Language (WSDL), and Universal Description, Discovery, and Integration (UDDI). SOAP defines an XML messaging protocol for basic service interoperability. WSDL introduces a common grammar for describing services. UDDI provides the infrastructure required to publish and discover services in a systematic way. Together, these specifications allow applications to find each other and interact following a loosely coupled, platform-independent model.

Presently, the interaction model that is directly supported by WSDL essentially can be viewed as a stateless model of synchronous or uncorrelated asynchronous interactions. Models for business interactions typically assume sequences of peer-to-peer message exchanges, both synchronous and asynchronous, within stateful, long-running interactions involving two or more parties. Nevertheless, systems integration requires more than the mere ability to conduct simple interactions by using standard protocols. The full potential of Web Services as an integration platform will be achieved only when applications and business processes are able to integrate their complex interactions by using a standard process integration model.

The Business Process Execution Language for Web Services (BPEL4WS) fulfills some aspects of a standard process integration model. The BPEL4WS specification defines a technology for integrating cross-enterprise business processes. By coordinating stateful interactions of loosely coupled services across enterprise boundaries, the BPEL4WS technology provides a means of modeling the interactions between an enterprise and its business partners, suppliers and customers and thus the value chain of the enterprise. More particularly, BPEL4WS defines a notation for specifying business process behavior based on Web Services.

BPEL4WS provides a language for the formal specification of business processes and business interaction protocols. By doing so, BPEL4WS extends the Web Services interaction model and enables the model to support business transactions. The basic concepts of BPEL4WS can be applied in one of two ways. A BPEL4WS process can define a business protocol role, using the notion of an abstract process. The relationship between two or more business protocol roles can be modeled as a partner link. Similarly, it is also possible to use BPEL4WS to define an executable business process. In an executable business process, the logic and state of the process determine the nature and sequence of the Web Service interactions conducted at each business partner, and thus the interaction protocols.

When coordination interactions among Web services, it can be important to ensure that business critical interactions are atomic, consistent, and durable by remaining isolated from other transactions. The WS-Transaction and WS-Coordination specifications collectively form a model for defining business activities that support the coordination, correlation and fault handling semantics across a business process. Specifically, WS-Coordination provides developers with a way to manage the operations related to a business activity, while WS-Transaction specifies two coordination types: atomic transactions and business activities which can be used with the extensible coordination framework described in the WS-Coordination specification.

In respect to WS-Coordination, a business process may involve a number of Web services working together to provide a common solution. Each service must coordinate its activities with those of the other services for the process to succeed. Coordination generally involves the sequencing of operations in a process to reach an agreement on the overall outcome of the business process. To that end, WS-Coordination provides the structure under which coordination can take place. Specifically, the WS-Coordination specification supplies standard mechanisms for the creation and registration of transaction protocols that coordinate the execution of distributed operations in a Web services environment.

WS-Transaction, by comparison, facilitates the monitoring of the success or failure of each specific, coordinated activity in a business process. WS-Transaction further provides a flexible transaction protocol to enable consistent and reliable operations across distributed organizations in a Web services environment. Finally, the WS-Transaction specification allows business processes to react to faults detected during execution. Notably, WS-Transaction provides for short- and long-running transactions in which resources cannot be locked for the duration of the business process. In both cases, WS-Transaction takes advantage of the structure WS-Coordination provides to enable all participating Web services to end the business process with a shared understanding of its outcome.

Importantly, BPEL4WS can be limited to the static deployment of selected business processes. In fact, whereas BPEL4WS provides for a statically specified principal supporting service for each activity defined in a deployed process, BPEL4WS does not permit the dynamic specification of a new principal service for an activity defined in a deployed process. The modern, on-demand computing vision, however, demands that the enterprise support a level of business transformation which is informed by timely and relevant business insights. Consequently, comprehensive business transformations require not only the modification of executable business processes, but also the adaptation of partner, supplier and customer interactions modeled by BPEL4WS as business protocols, or abstract processes.

Co-pending U.S. patent application Ser. No. 10/848,322 discloses the dynamic binding of partner links to end point references in a cross-enterprise business process management system for the adaptation of business process links through business transformations. Specifically, as described in co-pending U.S. patent application Ser. No. 10/848,322, the contents of which are incorporated herein by reference, principal services supporting corresponding business process activities in a business process sequence can be dynamically substituted with other business process activities subsequent to the deployment of the business process.

To support the dynamic substitution of business process activities subsequent to the deployment of the business processes, within the business process defining document, a partner link can be disposed in the business process defining document to process service requests supported by the principal service. The endpoint reference to the principal service in the partner link can vary, however, once the business process has been deployed. Consequently, different principal services can alternately support service requests even once the business process has been deployed merely by changing the endpoint reference in the partner link.

It will be noted that the BPEL4WS architecture described in co-pending U.S. patent application Ser. No. 10/848,322 can support business processes having associated transactional semantics defining an adaptive value chain. As such, care must be taken to ensure that transactional semantics are not violated by the underlying business transformation system when transforming a business process by varying the business activities supporting the process. Yet, business transformation operations that are imposed on the value chain as a result of business transformation directives should be atomic in order to ensure that the business process does not interfere with the transformation process under the guise of normal processing.

### SUMMARY OF THE INVENTION

The present invention addresses the deficiencies of the art in respect to cross-enterprise business process interaction and provides a novel and non-obvious method, system and apparatus for maintaining transactional integrity within an adaptive value chain involving cross business interactions. In accordance with the present invention, a method for maintaining transactional integrity in a cross-enterprise business process management system can include managing business transformation operations among cross-enterprise interactions to produce an adaptive value chain and, enforcing atomicity among the business transformation operations and the cross-enterprise interactions.

The enforcing step can include extending a business process described by the business process specification document to a business activity. The business activity can include each of a monitor, an activation service, a registration service and a coordination service in order to support business activity monitoring and transaction related protocols. The business activity monitoring and transaction related protocols further can enforce transactional semantics required to ensure business transformation operative integrity. The enforcing step further can include extending a business transformation engine to support the transaction semantics to allow informed business transformation operatives to participate in atomic transaction protocols.

A cross-enterprise business process management system configured for maintaining transactional integrity can include a business process specification document processing engine configured to process business process specification documents. Each of the documents can describe a business process having one or more business protocols defined within the business process. The system also can include a deployment service coupled to the engine and programmed to generate and deploy service instances supporting corresponding ones of the business protocols defined in the business process. The system yet further can include a business transformation engine coupled to the business process specification document processing engine.

The business transformation engine can be configured to process transformation scripts for changing the business process by activating and deactivating selected ones of the business protocols in the business process according to registered event personas and business transformation operatives. Notably, the system can include an extension to the business transformation engine. The extension can include a business activity configured to coordinate business transformations to maintain transactional integrity among the business protocols and the business transformations. In this regard, the business activity can include an aggregation of an activity monitor, an activation service, a registration service and a coordination service. Finally, the business activity can implement a business agreement coordination protocol.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a cross-enterprise business process interaction system which has been configured for maintaining transactional integrity within adaptive value chain involving cross business interactions in accordance with the inventive arrangements;

FIG. 2 is a flow chart illustrating a process for deploying a BPEL process to support coordination protocol tunneling in the adaptive value chain of FIG. 1; and,

FIG. 3 is a flow chart illustrating a process for ensuring the maintenance of transaction integrity in the adaptive value chain of FIG. 1.

### DETAILED DESCRIPTION OF THE PREFERRED EMBODIMENTS

The present invention is a method, system and apparatus for maintaining transactional integrity within an adaptive value chain involving cross enterprise interactions. In accordance with the present invention, transactional integrity can be maintained in a cross-enterprise business process management system by managing business transformation operations among cross-enterprise interactions to produce an adaptive value chain. At the same time, atomicity can be enforced among the business transformation operations and the cross-enterprise interactions.

Atomicity can be enforced by extending a business process described by the business process specification document to a business activity. The business activity can include each of a monitor, an activation service, a registration service and a coordination service in order to support business activity monitoring and transaction related protocols. The business activity monitoring and transaction related protocols further can enforce transactional semantics required to ensure business transformation operative integrity. Finally, a business transformation engine can be extended to support the transaction semantics to allow informed business transformation operatives to participate in atomic transaction protocols.

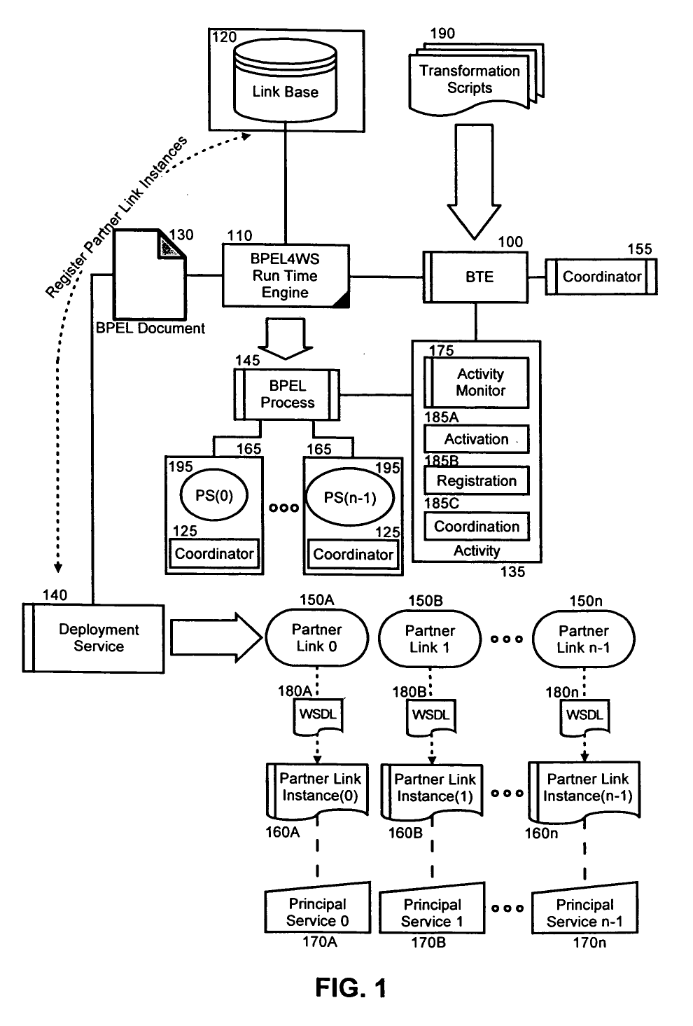

FIG. 1 is a schematic illustration of a cross-enterprise business process interaction system which has been configured for maintaining transactional integrity in accordance with the inventive arrangements. The system can include a business process specification document processing engine configured to process business process specification documents. Business process specification documents are documents—for instance markup language documents—which define the sequence of a business process. Typically associated with Web services, the business process specification documents also include information regarding the location and addressability of Web services programmed to implement activities in the sequence of the business process.

In a preferred aspect of the invention, the business process specification document processing engine can be a business process execution language (BPEL) run-time engine 110. As such, the BPEL run-time engine 110 can be configured to process a BPEL conforming document 130 by deploying Web services to support the activities of the business process defined within the BPEL document 130. In this regard, the BPEL run-time engine 110 can process a sequence of defined activities in the BPEL document 130 to identify a workflow of activities in the BPEL document 130, and also a set of messages responsive to which the BPEL run-time engine 110 can manage the invocation of selected ones of the deployed Web services. As an example, the BPEL run-time engine 110 can be a BPEL run-time engine configured to process BPEL4WS compliant documents.

A deployment service 140 can be coupled to the BPEL run-time engine 110. The deployment service 140 can be configured to re-factor artifacts associated with the BPEL document 130, including for example, the BPEL document 130 itself in addition to corresponding WSDL documents. A link base authority 120 can be communicatively linked to the deployment service 140. The link base authority 120 can be a Web service programmed to manage an XLink link base document. The XLink link base document can serve as a registry for all information related to the business process described in the BPEL document 130. Importantly, the BPEL run-time engine 110 can be configured with an XLink interpreter (not shown) to process Xlinks in the link base authority 120.

One or more partner links 150A, 150B, 150n can be defined within the BPEL document 130, each of the partner links 150A, 150B, 150n representing a role in the business process described within the BPEL document 130. For each defined partner link 150A, 150B, 150n, a corresponding partner link instance 160A, 160B, 160n can be created as a Web service along with a WSDL document 180A, 180B, 180n. The partner link instances 160A, 160B, 160n can embody the role of corresponding partner links 150A, 150B, 150n defined within the BPEL document 130. Each of the partner link instances 160A, 160B, 160n further can include a specification of an endpoint address for a principal service 170A, 170B, 170n designated to support the role associated with a corresponding one of the partner links 150A, 150B, 150n.

In accordance with the inventive arrangements, a business transformation engine (BTE) 100 can be coupled to the BPEL run-time engine 110. The BTE 100 can be a Web service extension to the BPEL run-time engine 100. The BTE 100 can be programmed to process transformation scripts 190, each of which can express business insights and business agreements coordinated with business transformation actions. Specifically, each of the scripts 190 can include conditional expressions which trigger actions responsive to the detection of mapped business transformation events. To that end, event handlers can be associated with the conditional expressions during the deployment process of the BPEL document 130.

In operation, when deploying a new business process defined by the BPEL document 130, the deployment service 140 can generate partner link instances 160A, 160B, 160n for each partner link 150A, 150B, 150n defined in the BPEL document 130. In particular, each of the partner link instances 160A, 160B, 160n can be created based upon a corresponding WSDL document 180A, 180B, 180n provided to the deployment service 140 in association with the BPEL document 130. Notably, each of the partner link instances 160A, 160B, 160n can include a skeletal structure acting as an interface to the underlying ones of the principal services 170A, 170B, 170n. When bound and deployed as a Web service, each of the partner link instances 160A, 160B, 160n thus can act as a proxy for corresponding ones of the principal services 170A, 170B, 170n.

The deployment service 140, having created the partner link instances 160A, 160B, 160n can register each of the partner link instances 160A, 160B, 160n with the link base authority 120. As a result, any one of the partner link instances 160A, 160B, 160n can be notified when an endpoint reference to a corresponding one of the principal services 170A, 170B, 170n has changed. Once the partner link instances 160A, 160B, 160n have been registered with the link base authority 120, the BPEL document 130 and its corresponding WSDL document (not shown) can be re-factored so that the partner link instances 160A, 160B, 160n are utilized in lieu of a direct utilization of the principal services 170A, 170B, 170n. Specifically, the WSDL documents 180A, 180B, 180n for each partner link 150A, 150B, 150n can be modified to point to the newly deployed partner link instances 160A, 160B, 160n.

Within the BPEL document 130 itself, an event handler (not shown) can be included and configured to update the endpoint reference information of the partner link instances 160A, 160B, 160n responsive to the occurrence of specified events. Consequently, the WSDL document (not shown) for the BPEL document 130 can be updated to reflect the presence of the event handler. Once the BPEL document 130 and the companion WSDL document (not shown) have been re-factored, one or more XLinks for the business process can be registered with the link base authority 120. In this regard, each XLink can bind a partner link 150A, 150B, 150n to a principal service 170A, 170B, 170n by way of the partner link instances 160A, 160B, 160n. When complete, the re-factored BPEL document 130 and the companion WSDL document (not shown) can be deployed along with the WSDL documents 180A, 180B, 108n by the BPEL run-time engine 110.

In accordance with the present invention, the BPEL process 145 produced through the execution of the BPEL document 130 can be extended with ancillary services which provide support for monitoring business activities and coordinating transaction related protocols in order to enforce transactional semantics defined by business process developers as well as transactional semantics required in order to ensure the integrity of business transformation operatives. To that end, a business activity 135 can be implemented as an aggregation of a business activity monitor 175, an activation service 185A, a registration service 185B and one or more coordination protocol services 185C. Additionally, a coordinator 155 can be included for coordinating the participation of partner services 195 in the business activity 135.

The business activity monitor 175 can include operations and logic that manage the coordination of the tasks defining the business activity 135. Consequently, the transaction semantics implemented by partner services 195 can be exposed as BPEL activities 165 when coordination is required across transactional domains. Moreover, the coordination logic 125 for the partner services 195 can be defined through the business activity monitor 175. As such, the business activity monitor 175 can act as the parent scope for the business activity 135 and can implement a guardian port type.

In operation, the BPEL process 145 can tunnel coordination protocol messages between the child and parent scopes by defining a partner link with the business activity monitor 175 along with the corresponding partner links to the individual partner services 195 participating in the BPEL process 145. In this regard, participants in the business activity 135 can enter and exit from the business activity 135 during the processing of the business activity 135. Accordingly, all partner services 195 and related BPEL activities 165 that interact within the business activity 135 can be incorporated as child scopes which implement the dependent port type.

To accommodate the activity 135, the business transformation engine 100 can be extended to support transaction semantics. By extending the business transformation engine 100, informed business transformation operatives can participate in atomic transaction protocols. Moreover, the business transformation engine 100 can be extended to act as the ultimate scope for business activities within the adaptive value chain by implementing a business transformation activity which implements a business agreement coordination type such as that supported by WS-Transaction.

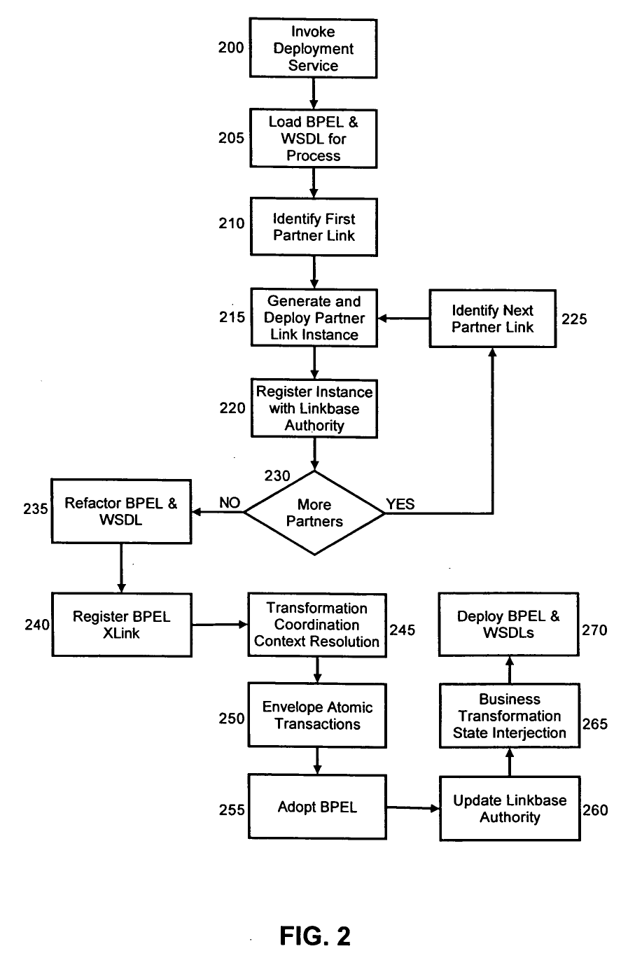

Turning now to FIG. 2, a flow chart is shown which illustrates a process for deploying a BPEL process to support coordination protocol tunneling in the adaptive value chain of FIG. 1. Beginning in block 200, the deployment service can be invoked. Specifically, the deployment service can be invoked by calling the deploy operation of the BPEL run-time engine and by passing a BPEL document and a companion WSDL document to the deployment service. Additionally, the WSDL documents for the partner links specified in the BPEL document further can be passed to the deployment service.

In block 205, the BPEL document and companion WSDL document can be loaded for processing. In block 210, a first partner link can be identified in the BPEL document. In block 215, a partner link instance can be generated and deployed for the first partner link. Specifically, the WSDL document for the identified partner link can be used to generate a skeleton and a service that reflects the actual interface of a corresponding principal service. The partner link instance can be bound and deployed as a Web service which acts as a proxy for the principal service. An exemplary WSDL fragment follows:

```
<wsdl:service name = “MyPTService”>
  <wsdl:port binding=“namespace:MyServiceSoapBinding”
  name=“MyService”>
    <wsdlsoap:address location=“http://localhost:8080/appserver/
    MyAuxService”/>
  </wsdl:port>
</wsdl:service>
```

In block 220, the partner link instance can be registered with the link base authority. An exemplary XLink fragment follows:

```
<baseResource id=“PRIMARY_SERVICE_AUX”
xlink:type=“extended”>
  <baseResourceRef xlink:type=“locator”
    xlink:href=“http://mycompany.com/primary_service_aux”
    xlink:role=“PARTNER_LINK_INSTANCE”
    xlink:label=“PRIMARY_SERVICE_AUX” />
</baseResource>
```

The registration of the partner link instance can result in the notification of the partner link instance when its associated endpoint reference to a supporting principal service has changed. In blocks 225 and 230, the process of generating and deploying partner link instances for identified partner links, and also of registering the partner link instances with the link base authority can repeat for each identified partner link in the BPEL document. Subsequently, the process can continue in block 235 through block 270.

In block 235 the BPEL document and the WSDL document for the business process can be re-factored. More particularly, each partner link specified in the BPEL document can be changed to reflect a correspondence to the partner link instance created and deployed in block 215. Finally, in block 240, the XLinks for the business process defined in the BPEL document can be registered with the link base authority. In this regard, an XLink stored in the link base authority can bind the partner link role to the principal service along with the partner link instance to a partner link. If a partner link is mapped to a new principal service, then the partner link instance that is mapped to a specific partner link can be updated with a new endpoint address.

Notably, in block 245 the BPEL document can be modified to support an event handler capable of processing a coordination context which can be stored in a global variable. In block 250, all partner links having a role which supports one or more specified coordination protocols can be extended to support a business agreement coordination protocol. As an example, business agreement coordination protocols can include two phase commit (volatile or durable), completion with acknowledgment, completion or outcome notification, to name a few. The extension can be accomplished by interposing the coordinator of the business transformation engine with the native business activity monitor coordinator. Moreover, an XLink also can be registered which defines which atomic transactions and business activities are to be considered mutually exclusive from the business transformation.

In block 255, the BPEL document can be adopted. Specifically, the BPEL document which defines a partner link with the business transformation engine can include a role attribute which can be defined to support the dependent port type. As such, the BPEL process can be enabled to operate within a child scope of the business transformation engine. In block 260, the LinkBase can be updated in that the XLinks which correlate coordination context identifiers with coordination protocols can be registered with the LinkBase. Notably, WS-Policy files can be used to define the coordination protocol and as a result can be considered base resources.

In any event, in block 265 the BPEL document can be extended to support activities for reading and writing to a global variable indicating when a business transformation is underway. This extension provides a means for third parties to resolve the transformation state of the BPEL process—particularly those third parties which do not participate in the business transformation activities coordination protocol. Finally, in block 270 the BPEL document and the re-factored WSDL document can be deployed for use by the BPEL run-time engine.

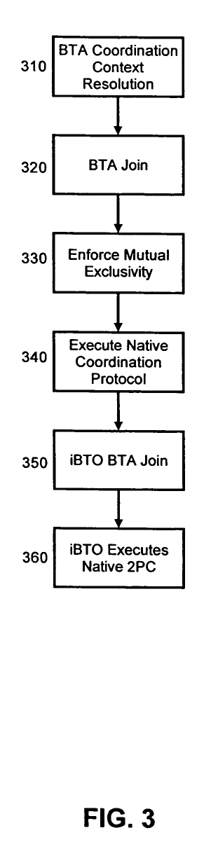

In accordance with the present invention, once the BPEL process has been deployed, the transaction integrity of activities executing in the BPEL process can be maintained programmatically across the adaptive value chain. Specifically, FIG. 3 is a flow chart illustrating a process for ensuring the maintenance of transaction integrity in the adaptive value chain of FIG. 1. Beginning in block 310, when a notification is received indicating the instantiation of a BPEL process instance, a message can be transmitted to the business transformation engine which in turn can forward the coordination context for the BPEL process instance to the event handler of the BPEL process. The event handler, in turn, can store the coordination context in a variable which further can include an end point reference for the registration service of the coordinator for the business transformation engine.

In block 320, BPEL activities which have been enveloped can join the business transformation activity. After activation of the coordination context for the business activity monitor, the business transformation engine coordinator can be interposed by transmitting the coordination context that includes an end point reference for the registration service of the business activity monitor. The coordinator for the business activity monitor, in turn, can return an identical coordination context with the end point reference replaced with that of the registration service for the coordinator of the business transformation engine. Subsequently, in block 330, the business transformation engine can consult with the LinkBase to determine if an ongoing business transformation will prevent the execution of the coordination protocol. If a business transformation is in progress, the business transformation engine can block the execution of the coordination protocol until the completion of the ongoing business transformation.

When not blocked by the business transformation engine, in block 340, through the interposition of the coordinator of the business transformation engine, the BPEL activity can proceed to execute the coordination protocol as requested. Notably, in block 350, prior to the completion of the execution of the coordination protocol, it is possible that a business transformation can be initiated by an informed business transformation operative attempting to join the business transformation activity by registering the business transformation with the coordinator for the business transformation engine. In this circumstance, the business transformation engine can block the business transformation until the coordination protocol can reached a completion state.

Finally, in block 360, when the coordination protocol has reached a completion state, the business transformation engine can invoke the event handler for the BPEL process to update the global variable to indicate the completion of the coordination protocol. Consequently, the transactional integrity for the adaptive value chain can be maintained thereby ensuring that the integrity of the original business process is maintained while also ensuring that business transformations are not corrupted by uninformed business activities.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A method for maintaining transactional integrity in a cross-enterprise business process management system, the method comprising the steps of:
managing business transformation operations among cross-enterprise interactions to produce an adaptive value chain; and,
enforcing atomicity among said business transformation operations and said cross-enterprise interactions.

2. The method of claim 1, wherein said enforcing step comprises the steps of:
extending a business process described by said business process specification document to a business activity having each of a monitor, an activation service, a registration service and a coordination service to support business activity monitoring and transaction related protocols in order to enforce transactional semantics required to ensure business transformation operative integrity; and,
extending a business transformation engine to support said transaction semantics to allow informed business transformation operatives to participate in atomic transaction protocols.

3. The method of claim 2, further comprising the step of further extending said business transformation engine to act as a parent scope for business activities within said adaptive value chain.

4. The method of claim 3, wherein said further extending step comprises the step of implementing a business transformation activity implementing a business agreement coordination protocol.

5. The method of claim 3, wherein said further extending step comprises the step of tunneling coordination protocol messages between parent and child scopes for said business process by defining a partner link with said monitor along with corresponding partner links to individual partner services participating in said business process.

6. The method of claim 1, wherein said managing step comprises the steps of:
deploying a partner link instance for each partner link specified in a business process specification document;
re-factoring said document to bind each said partner link to each said deployed partner link instance in lieu of a direct binding to a principal service;
adding an event handler to said business process specification document to handle a dynamic change to an endpoint reference to said principal service; and,
registering each of said partner link instances to receive notification of a change to an endpoint reference to a principal service.

7. The method of claim 6, further comprising the steps of:
invoking said event handler;
changing an endpoint reference to a principal service bound to a deployed partner link instance;
notifying said deployed partner link instance that a change to said endpoint reference has occurred; and,
modifying subsequent service calls to said principal service to reflect said changed endpoint reference.

8. A cross-enterprise business process management system configured for maintaining transactional integrity comprising:
a business process specification document processing engine configured to process business process specification documents, each of said documents describing a business process having a plurality of business protocols defined within said business process;
a deployment service coupled to said engine and programmed to generate and deploy service instances supporting corresponding ones of said business protocols defined in said business process;
a business transformation engine coupled to said business process specification document processing engine and configured to process transformation scripts for changing said business process by activating and deactivating selected ones of said business protocols in said business process according to registered event personas and business transformation operatives; and,
an extension to said business transformation engine, said extension comprising a business activity configured to coordinate business transformations to maintain transactional integrity among said business protocols and said business transformations.

9. The system of claim 8, wherein said business activity implements a business agreement coordination protocol.

10. The system of claim 8, wherein said business activity comprises an aggregation of an activity monitor, an activation service, a registration service and a coordination service.

11. The system of claim 8, wherein said business process specification documents comprise business process execution language (BPEL) documents.

12. The system of claim 11, wherein said business process specification document processing engine comprises a business process execution language for Web services (BPEL4WS) run-time engine.

13. The system of claim 12, wherein said business process comprises a sequence of business activities embodied within corresponding Web services.

14. A machine readable storage having stored thereon a computer program for maintaining transactional integrity in a cross-enterprise business process management system, the computer program comprising a routine set of instructions which when executed by a machine cause the machine to perform the steps of:
managing business transformation operations among cross-enterprise interactions to produce an adaptive value chain; and,
enforcing atomicity among said business transformation operations and said cross-enterprise interactions.

15. The machine readable storage of claim 14, wherein said enforcing step comprises the steps of:
extending a business process described by said business process specification document to a business activity having each of a monitor, an activation service, a registration service and a coordination service to support business activity monitoring and transaction related protocols in order to enforce transactional semantics required to ensure business transformation operative integrity; and,
extending a business transformation engine to support said transaction semantics to allow informed business transformation operatives to participate in atomic transaction protocols.

16. The machine readable storage of claim 15, further comprising an additional set of instructions for causing the machine to further perform the step of further extending said business transformation engine to act as a parent scope for business activities within said adaptive value chain.

17. The machine readable storage of claim 16, wherein said further extending step comprises the step of implementing a business transformation activity implementing a business agreement coordination protocol.

18. The machine readable storage of claim 16, wherein said further extending step comprises the step of tunneling coordination protocol messages between parent and child scopes for said business process by defining a partner link with said monitor along with corresponding partner links to individual partner services participating in said business process.

19. The machine readable storage of claim 14, wherein said managing step comprises the steps of:
deploying a partner link instance for each partner link specified in a business process specification document;
re-factoring said document to bind each said partner link to each said deployed partner link instance in lieu of a direct binding to a principal service;
adding an event handler to said business process specification document to handle a dynamic change to an endpoint reference to said principal service; and,
registering each of said partner link instances to receive notification of a change to an endpoint reference to a principal service.

20. The machine readable storage of claim 19, further comprising an additional set of instructions for causing the machine to further perform the steps of:
invoking said event handler;
changing an endpoint reference to a principal service bound to a deployed partner link instance;
notifying said deployed partner link instance that a change to said endpoint reference has occurred; and,
modifying subsequent service calls to said principal service to reflect said changed endpoint reference.
